(19) United States
(12) Patent Application Publication
(10) Pub. No.: US 2009/0134214 A1
(43) Pub. Date: May 28, 2009

(54) TRANSACTION SYSTEMS AND METHODS

(76) Inventor: Joseph R. Randazza, Boca Raton, FL (US)

Correspondence Address: JEROME D. JACKSON (JACKSON PATENT LAW OFFICE), 211 N. UNION STREET, SUITE 100, ALEXANDRIA, VA, 22314, US

(21) Appl. No.: 11/963,998

(22) Filed: Dec. 24, 2007

Related U.S. Application Data
(60) Provisional application No. 60/985,996, filed on Nov. 7, 2007.

(51) Int. Cl. G06Q 40/00

(52) U.S. Cl. 235/379

(57) ABSTRACT

Disclosed are transaction system and methods.

This Application claims the benefit of U.S. application Ser. No. 60/985,996 of JOSEPH R. RANDAZZA filed Nov. 7, 2007 for TRANSACTION SYSTEMS AND METHODS, the contents of which are herein incorporated by reference.

This Application is a continuation-in-part of U.S. application Ser. No. 11/938,279 of JOSEPH R. RANDAZZA AND DANILO PORTAL filed Nov. 10, 2007 for PAYMENT SYSTEMS AND METHODS, the contents of which are herein incorporated by reference, which is a continuation-in-part of U.S. application Ser. No. 11/692,172 of JOSEPH R. RANDAZZA AND DANILO PORTAL filed Mar. 27, 2007 for PAYMENT SYSTEMS AND METHODS, the contents of which are herein incorporated by reference, which is a continuation-in-part of U.S. application Ser. No. 11/539,636 of JOSEPH R. RANDAZZA AND DANILO PORTAL filed Oct. 8, 2006 for PAYMENT SYSTEMS AND METHODS, the contents of which are herein incorporated by reference.

application Ser. No. 11/692,172 claims the benefit of Provisional Application Ser. No. 60/786,830 of JOSEPH R. RANDAZZA AND DANILO PORTAL filed Mar. 29, 2006 for PAYMENT SYSTEMS AND METHODS, the contents of which are herein incorporated by reference.

application Ser. No. 11/539,636 claims the benefit of Provisional Application Ser. No. 60/724,806 of JOSEPH R. RANDAZZA AND DANILO PORTAL filed Oct. 11, 2005 for PAYMENT SYSTEMS AND METHODS, the contents of which are herein incorporated by reference. application Ser. No. 11/539,636 claims the benefit of Provisional Application Ser. No. 60/786,830 of JOSEPH R. RANDAZZA AND DANILO PORTAL filed Mar. 29, 2006 for PAYMENT SYSTEMS AND METHODS, the contents of which are herein incorporated by reference. application Ser. No. 11/539,636 claims the benefit of Provisional Application Ser. No. 60/791,217 of JOSEPH R. RANDAZZA AND DANILO PORTAL Apr. 12, 2006 for PAYMENT SYSTEMS AND METHODS, the contents of which are herein incorporated by reference.

### BACKGROUND OF THE INVENTION

### Field of the Invention

This invention relates generally to transaction systems and methods and, more particularly, to transaction systems and methods deployed in a retail environment.

### SUMMARY OF THE INVENTION

According to an aspect of the present invention, there is a method for a system having a plurality of retailers, a first person, and a bank checking account owned by the first person, the method operating with a card that was transferred to the first person at a time when the card was having only a single payment source, the single payment source being a monetary amount not associated with any bank account. The method comprises associating the card with the checking account owned by the first person; and performing a purchase, to debit the checking account.

According to another aspect of the present invention, there is a system for operating with a plurality of retailers, a first person, a bank checking account owned by the first person, and a card that was transferred to the first person at a time when the card was having only a single payment source, the single payment source being a monetary amount not associated with any bank account. The system comprises circuitry that acts to associate the card with the checking account owned by the first person; and circuitry that acts to conduct a purchase transaction, to debit the checking account.

According to yet another aspect of the present invention, there is a system for operating with a plurality of retailers, a first person, a checking account owned by the first person, and a card that was transferred to the first person at a time when the card was having only a single payment source, the single payment source being a monetary amount not associated with any bank account. The system comprises means for associating the card with the checking account owned by the first person; and means for conducting a purchase transaction, to debit the checking account.

According to yet another aspect of the present invention, there is a method for a system having a plurality of retailers, the method operating with a card that has been issued as a stored-value card. The method comprises performing a purchase by debiting a monetary amount associated with the card; detecting depletion of the monetary amount; and responsive to the detecting step, enabling purchases to be performed by debiting a bank checking account.

According to yet another aspect of the present invention, there is a system for operating with a plurality of retailers, and a card that has been issued as a stored-value card. The system comprises circuitry that conducts a purchase transaction by debiting a monetary amount associated with the card; circuitry that detects depletion of the monetary amount, to generate a first signal; and circuitry that enables, responsive to the first signal, purchases to be performed by debiting a bank checking account.

According to yet another aspect of the present invention, there is a method for a system having a plurality of persons; a plurality of cards issued under authority of a retailer; a first signal common to the plurality of cards; a routing system for receiving a signal and generating a network address in response to the received signal, the routing system including a plurality of wide area communication links, the routing system being configured using the first signal, the system further including a second signal on a first card in the plurality of cards; and a second system storing an association between the second signal and account information. The method comprises the steps, performed at the retail site, of receiving the first and second signals from the first card; sending the first and second signals into the routing system, to cause the second system to perform the steps of detecting depletion of a monetary amount associated with the first card, the monetary amount being committed to purchases with the retailer; responsive to the detecting step, determining whether the first card can effect payment, responsive to the determining step, conditionally sending a message to cause an institution to send an ACH entry to the Federal Reserve ACH system, to pass the entry to a bank, where an account is issued a debit, to cause a transfer of funds to the owner of the retail site, and making an entry in an accounting system, to effectively increment an amount owed by the owner of the retail site to the owner of the second system. The method further includes the step, performed at the retail site, of conditionally effecting a transaction with a holder of the first card, depending on a signal received from the second system.

### BRIEF DESCRIPTION OF THE DRAWINGS

References are made to the following text taken in connection with the accompanying drawings, in which:

FIG. 1 shows a retail system according to a first exemplary embodiment of the present invention.

FIGS. 2A and 2B shows another aspect of the first exemplary system.

FIGS. 3A and 3B show a retailer-branded card in the first exemplary system.

FIG. 4 show a computer generated display in a home in the first exemplary system.

FIGS. 5A, 5B, and 5C are a flowchart of a process performed in the first exemplary system.

FIG. 6 shows another aspect of the exemplary system.

FIGS. 7A, 7B, and 7C show a retail grocery store in the first exemplary system.

FIG. 8 is a diagram showing transaction flows in the first exemplary system.

FIG. 9 shows a retail system according to a second exemplary embodiment of the present invention.

FIGS. 10A and 10B show another aspect of the second exemplary system.

FIGS. 11A and 11B show a card in the second exemplary system.

FIGS. 12A and 12B shows computer generated displays in a home in the second exemplary system.

FIGS. 13A and 13B show another aspect of the third exemplary system.

FIGS. 14A and 14B show a card in the third exemplary system.

FIGS. 15A, 15B, and 15C shows computer generated displays in a home in the third exemplary system.

The accompanying drawings which are incorporated in and which constitute a part of this specification, illustrate embodiments of the invention and, together with the description, explain the principles of the invention, and additional advantages thereof. Certain drawings are not necessarily to scale, and certain features may be shown larger than relative actual size to facilitate a more clear description of those features. Throughout the drawings, corresponding elements are labeled with corresponding reference numbers.

### DETAILED DESCRIPTION OF EXEMPLARY EMBODIMENTS

### First Exemplary Embodiment

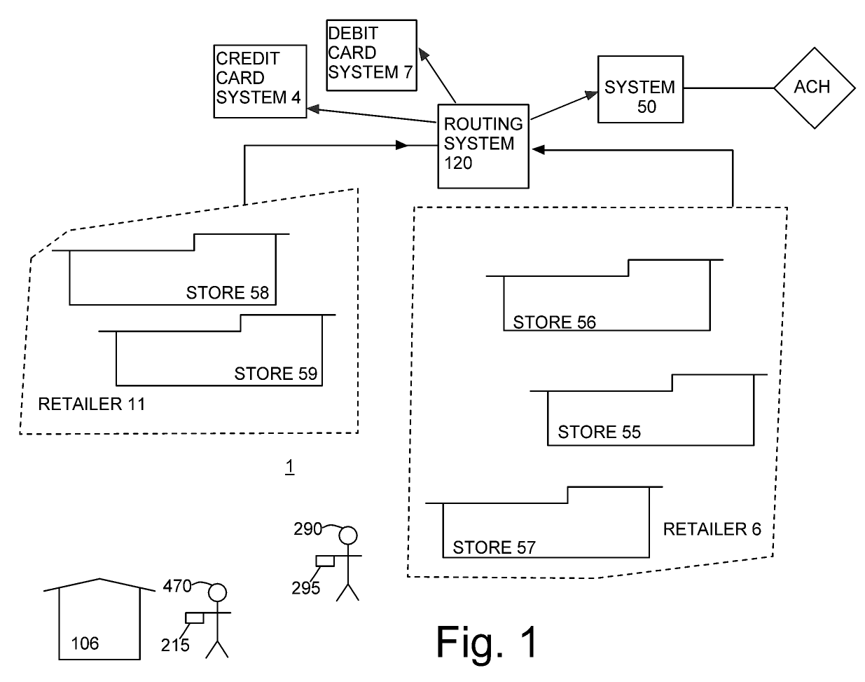

FIG. 1 shows exemplary system 1, including multiple persons, such as person 290 and person 470. Person 290 carries a retailer 6-branded card 295, which was issued as a gift card for purchases from retailer 6. Person 470 carries a retailer 6-branded card 215, which was issued as a gift card for purchases from retailer 6.

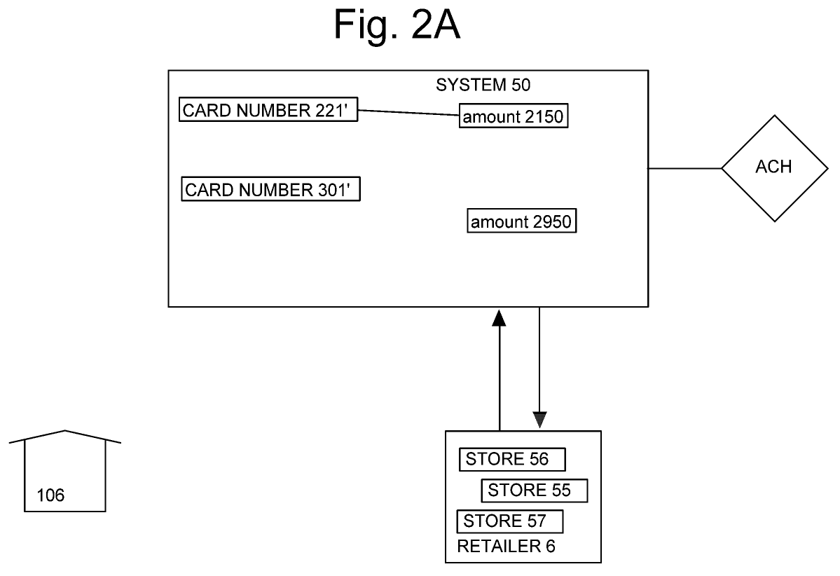

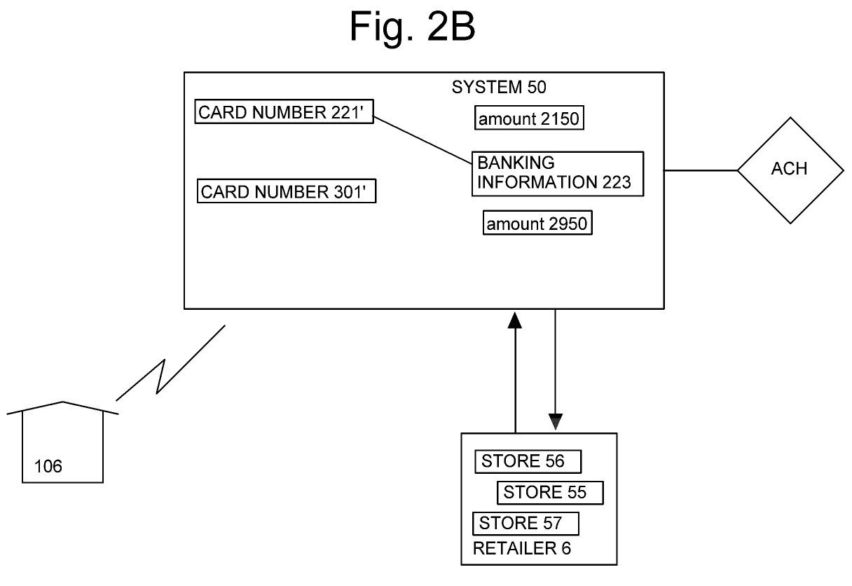

FIG. 2A emphasizes other aspects of System 1. System 1 includes gift card system 50, which communicates with retailer 6, via routing system 120. Services from payment processors—such as Comdata, Blackhawk Network, First Data, RBSlynk, and Fifth Third—may be configured to implement routing system 120.

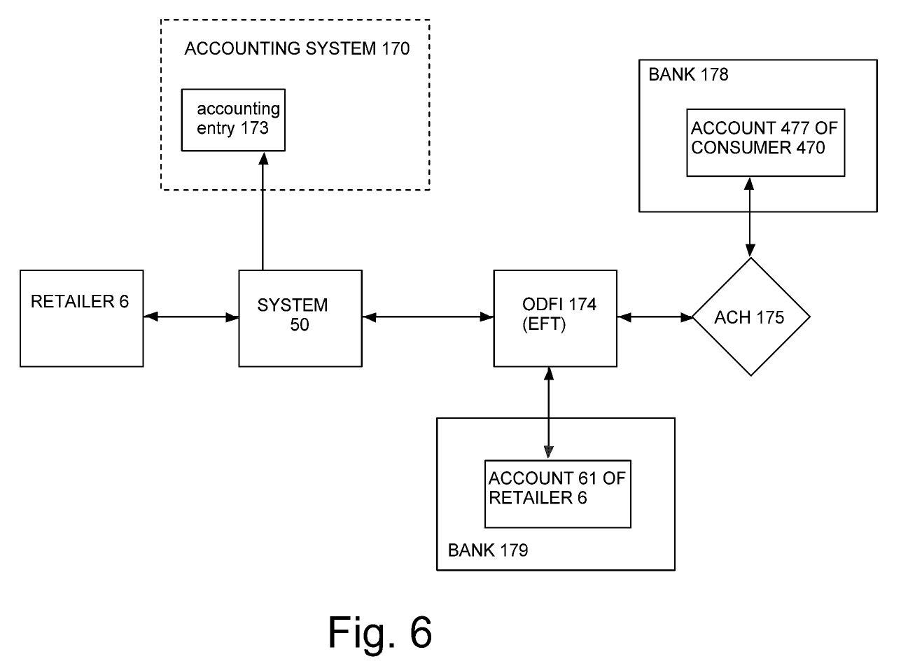

System 50, in a location such as Reston, Va., receives signals from retailer 6, to validate customer authorization at the time of a retail transaction. Depending on the status of card 215, system 50 may either debit monetary amount 2150 reserved for transactions with a retailer 6 (debit a monetary amount associated with a gift card for shopping at retailer 6), or debit demand bank account (checking account) 477 (FIG. 6), as discussed in more detail below.

The funds in amount 2150 are committed to (limited to) purchases in retailer 6. The funds in demand bank account 477 are not so committed.

A signal from a retailer to system 50 is represented by a directed line going from the retailer to system 50; and a signal from system 50 to a retailer is represented by a directed line going from system 50 to the retailer.

In response to a signal from system 50, retailer 6, for example, allows a customer transaction to proceed.

In the structures shown in system 50 depicted in FIG. 2A, lines represent a reference, such as a pointer, between one element and another. These references are not necessarily direct memory address pointers. Instead, more generally, each reference is a data entity, stored in association with one (referencing) element, that enables a processor to find a related (referenced) element. To physically address the referenced element, the processor may subject the reference to various translations or mappings.

System 50 receives a data packet from retailer 6, the data packet containing a card number, such as the card number of the card held by consumer 470. System 50 then uses the data structures shown in FIG. 2A to be to find a monetary amount to 2150, which is the remaining pre-paid amount for the card of consumer 470.

The owner of system 50 and the owner of retailer 6 are non-affiliated, meaning that they are not affiliates with respect to each other. Is this patent application, concerns are affiliates of each other when one concern controls or has the power to control the other, or a third party or parties controls or has the power to control both. Power to control is described in Section 121 of the U.S. regulations of the Small Business Administration.

The owner of system 50 and the owner of retailer 11 are non-affiliated.

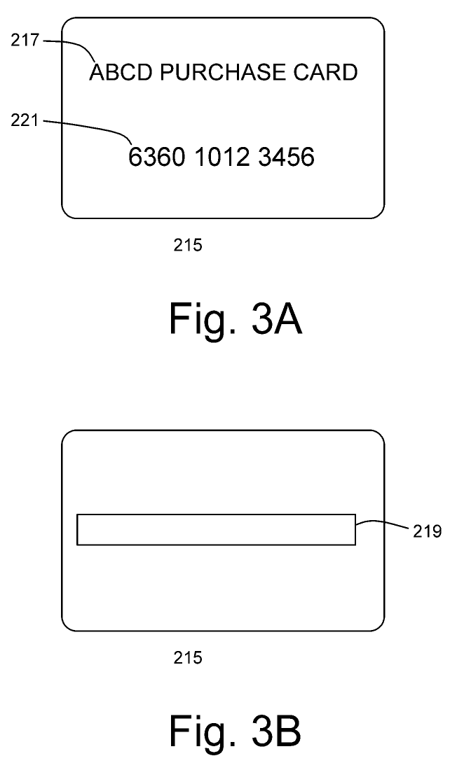

FIG. 3A shows a front, plan view of card 215 branded for the ABCD stores (retailer 6) and carried by person 470, who is a customer in system 1, and FIG. 3B shows a back, plan view of card 215. Card 215 includes magnetic stripe 219 storing the ID number 123456 and other information on the reverse side. Card number 123456 is unique to card 215. The system stores an association between ID number 123456 and monetary information.

Stripe 219 also stores the number 636010, indicating a card associated with retailer 6, in accordance with International Standard ISO 7812.

Retailer 6 sells card 215 in store 55. This selling of card 215, in a brick-and-mortar store, is one type of issuing of a card. Issuing of a card is one type of transferring of possession.

At the time of this issuance of card 215, card 215 does not display the name of consumer 470.

FIG. 2B shows certain structures at a subsequent time than that depicted in FIG. 2A. The differences between FIGS. 2A and 2B are attributable to consumer 470 having enrolled card 215. Enrollment includes compiling banking information 223, and associating card 215 with banking information 223. Banking information 223 includes the bank account number of bank account 477, and the ABA routing number of Bank 178. Banking information 223 also includes a user-selected personal identification number (PIN) for security.

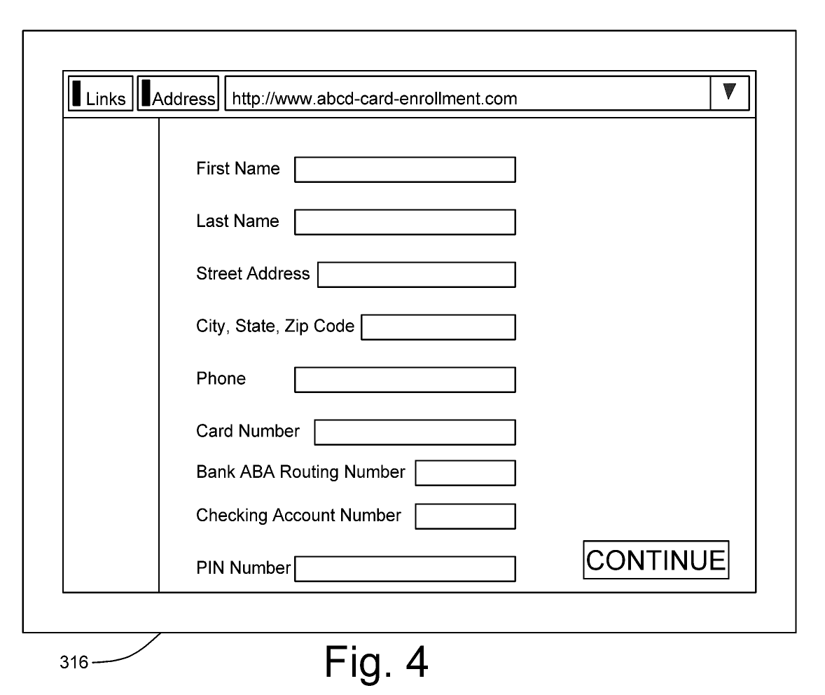

More specifically, consumer 470 is an owner of the demand bank account 477. Consumer 470 initiates an enrollment transaction via the World Wide Web, by using a personal computer in home 106 of consumer 470. Consumer 470 enrolls card 215 by using the personal computer to receive a page from a website. FIG. 4 shows computer display 316 displaying an enrollment page from the web site. Consumer 470 uses a keyboard to fill in each of the fields shown on the computer display 316, including the card number field, the bank ABA routing number field, and the checking account number field. Consumer 470 then activates the CONTINUE button, causing a packet to be sent from home 106 to system 50 via the World Wide Web. Circuitry in system 50 processes data in the received packet to generate banking information in 223 (FIG. 2B) and generate a reference from card number 221′ to banking information 223. Card number 221′ is a structure storing the value 636010123456, or storing a value corresponding to 636010123456.

In summary, in an exemplary method, a retailer-branded pre-paid card is issued when the card is purchased at a store. A consumer then enrolls the card into an ACH debit system, via her home computer and the World Wide Web. At the time of card issuance, the card does not display the name of the consumer.

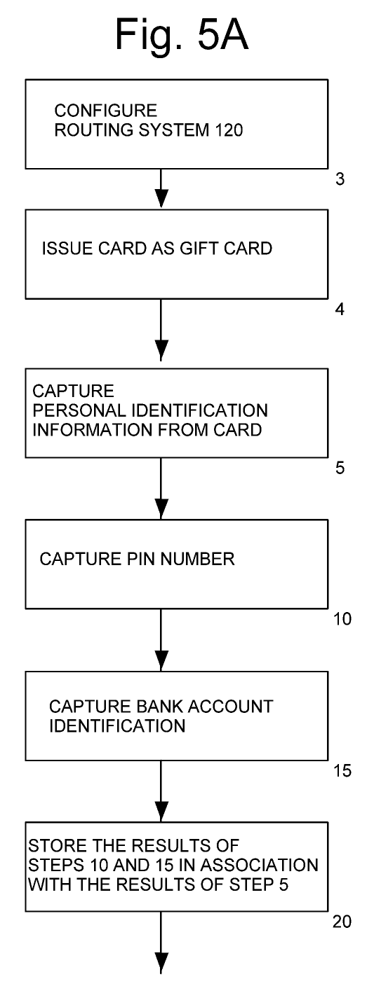

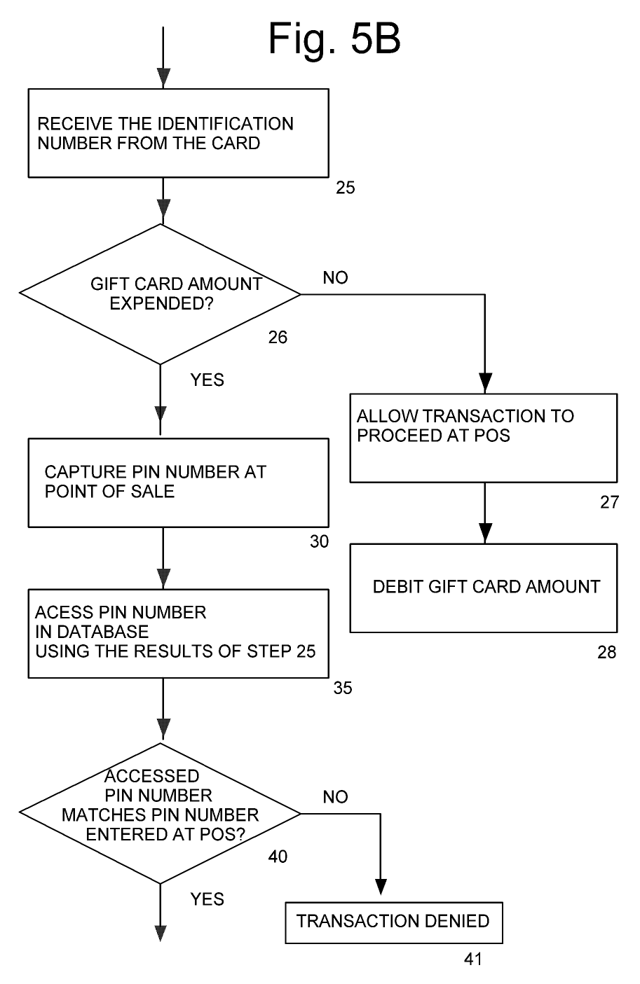

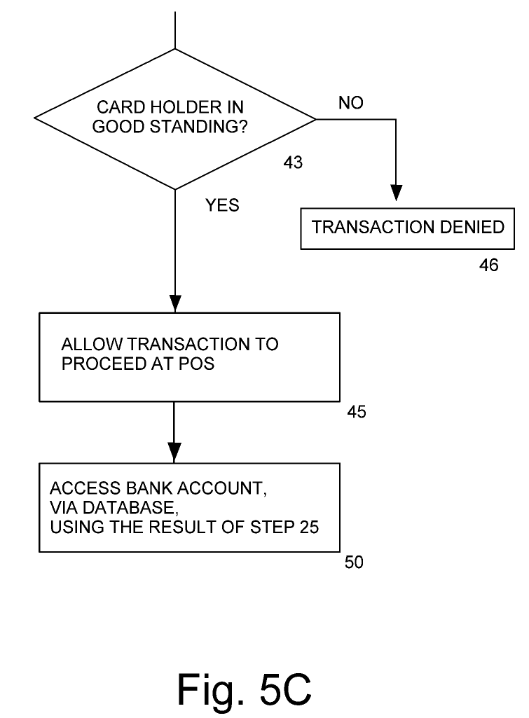

FIGS. 5A, 5B, and 5C show a process performed by circuitry in system 1. Step 3 includes configuring routing system 120, in accordance with a network address or network position, of system 50 (step 3), so that certain signals will be sent to system 50, as described in more detail below. A card, such as card 215, is issued as a gift card. (step 4).

After issuance of card 215, a consumer may initiate an enrollment transaction that compiles the card identification number (step 5); a personal identification number (PIN) for security (step 10); and bank routing number and the bank account number (step 15). This compilation is sent to system 50 and stored in association in a database (step 20).

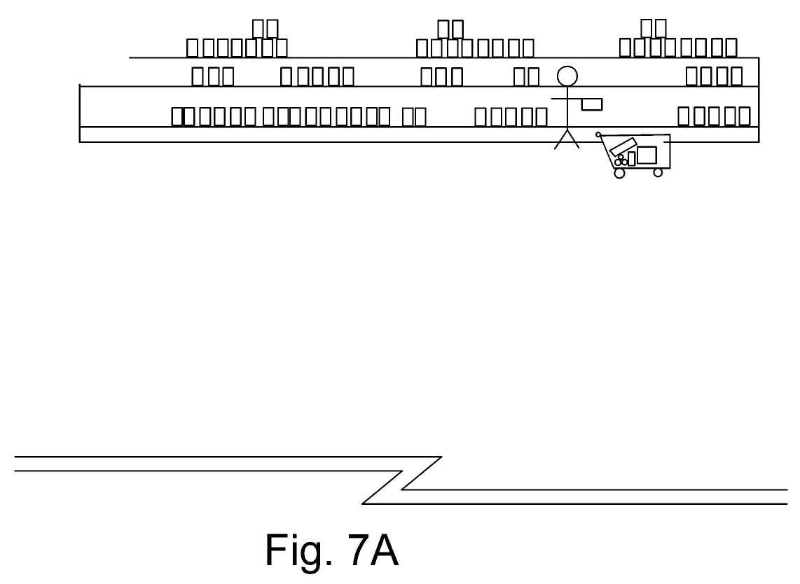

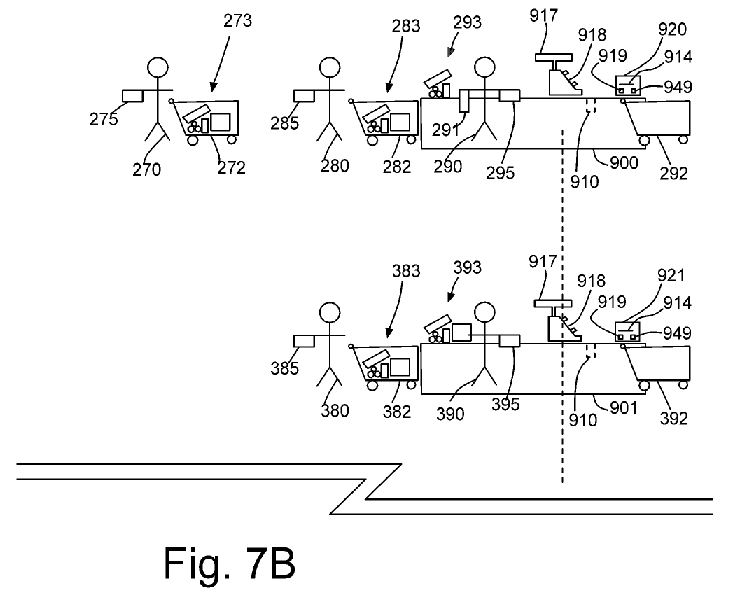

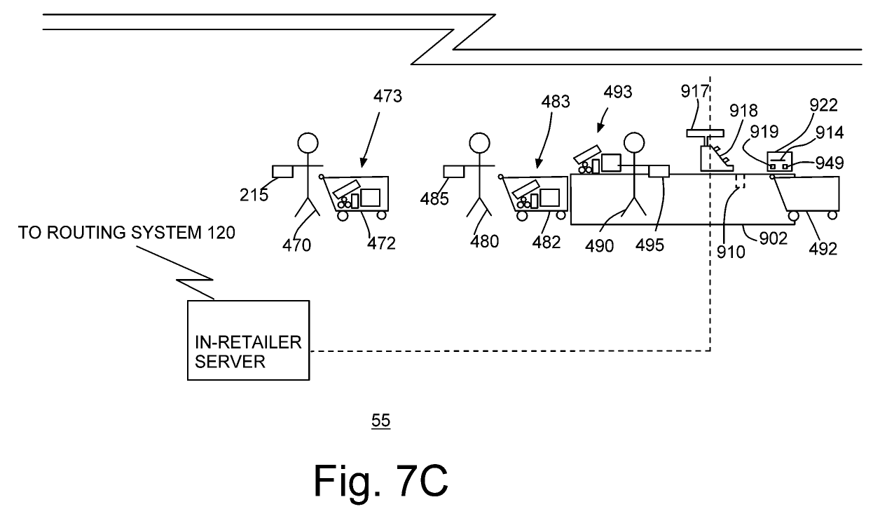

FIGS. 7A, 7B, and 7C show a context in which subsequent steps of the flow chart of FIGS. 5A, 5B, and 5C are performed. FIGS. 7A, 7B, and 7C are each a partial view of store 55 in retailer 6. Store 55 has a plurality of product areas, each corresponding to a respective product, and checkout stations 900, 901, and 902. Each checkout station includes a bar code reader that detects an optical (electromagnetic) signal reflected from a bar code, and a magnetic stripe reader that scans a magnetic card. Checkout station 900 includes payment terminal 920 having a card interface slot 914, checkout station 901 includes payment terminal 921 having a card interface slot 914, and checkout station 902 includes payment terminal 922 having a card interface slot 914. Each payment terminal includes a button 919 labeled “CREDIT” and a button 949 labeled “DEBIT”.

Upon completion of shopping, each customer brings selected products from the shelves to checkout station 900, 901, or 902.

Each customer presents her customer card. In this example, customer 490 presents credit card 495, which is associated with an installment payment account of customer 490. Customer 480 presents debit card 485, which is associated with a demand bank account of customer 480. Customer 470 presents system-50-registered retailer-branded card 215.

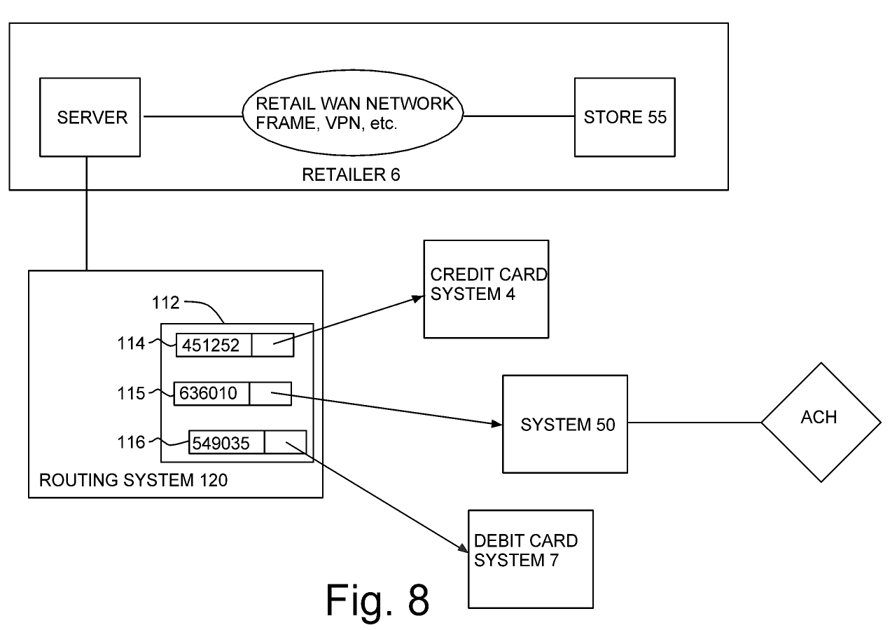

Customer 490 completes the purchase of her selected products 493 by transferring products 493 from her cart 492 to station 902, and by presenting card 495. A checkout clerk (not shown) scans each selected product past bar code reader 910, or enters the product selection information manually via keyboard 918. Checkout station 902 determines a total amount due and prints the total amount due on display 917. Customer 490 tenders the transaction with credit, or the system recognizes credit. In response, circuitry in retailer 10 transmits the account number of card 495 to a credit/debit card authorization provider, such as credit card system 4 shown in FIG. 8, via routing system 120.

In this Patent Application, the word circuitry encompasses dedicated hardware, and/or programmable hardware, such as a CPU or reconfigurable logic array, in combination with programming data, such as sequentially fetched CPU instructions or programming data for a reconfigurable array.

Customer 480 completes the purchase of her selected products 483 by transferring products 483 from her cart 482 to station 902, and by presenting card 485. The checkout clerk scans selected products past bar code reader 910. Checkout station 902 determines a total amount due and prints the total amount due on display 917. Customer 480 tenders the transaction with debit, or the system recognizes debit. In response, circuitry in payment terminal 922 prompts customer 480 to enter a personal identification number (PIN) into a keypad on terminal 922. Terminal 922 then applies an encryption key to the entered PIN, to generate an encrypted PIN. Circuitry in retailer 10 then transmits the encrypted PIN and the account number of card 485 to a credit/debit card authorization provider, such as debit card system 7 shown in FIG. 8, via routing system 120. Debit card system 7 could be operated by the Master Card Corporation.

Customer 470 completes the purchase of her selected products 473 by transferring products 473 from her cart 472 to station 902, and by presenting retailer-branded card 215. The checkout clerk scans selected products past bar code reader 910. Checkout station 902 determines a total amount due and prints the total amount due on display 917. Station 902 reads the ID information of person 470 from card 215, and reads the Issuer Identification Number, 636010, indicating a card issued for retailer 6, from retailer-branded card 215. (step 25) (FIG. 5B).

Retailer 6 then sends a data packet to signal to system 50, to identify card 215. If system 50 determines that gift card monetary amount 2150, dedicated to purchases from retailer 6, is non-zero (step 26), system 50 sends a data packet back to retailer 6 to allow the transaction to proceed (step 27) by debiting a quantity from monetary amount 2150 (step 28).

On the other hand, if system 50 determines that monetary amount 2150 is zero (step 26), circuitry in payment terminal 922 prompts customer 470 to enter a PIN into a keypad on terminal 922. Terminal 922 then applies an encryption key to the entered PIN, to generate an encrypted PIN. Circuitry in retailer 10 then transmits the encrypted PIN and the identification number of retailer-branded card 215 to system 50, via routing system 120.

Circuitry in system 50 uses the ID number of the card, transmitted by the server, to access the associated PIN stored in the database as a result of the enrollment process. (step 35). System 50 thus compares the PIN, transmitted by the store server, to the PIN read from the database. (step 40). Depending upon the result of step 40, system 50 may conditionally send a card-not-authorized signal to the store server. (step 41).

Step 43 includes real-time communication to system 50 to validate the card against a negative check database. Depending upon the result of step 43, system 50 conditionally responds to the store server with a signal, causing station 902 to allow customer 470 to carry away products 473. (step 45).

Otherwise system 50 sends a transaction-not-authorized signal to the store server. (step 46).

Step 43 may also include velocity checks known in the art. Step 43 may also include velocity checks described in U.S. application Ser. No. 11/692,172 of JOSEPH R. RANDAZZA AND DANILO PORTAL filed Mar. 27, 2007 for PAYMENT SYSTEMS AND METHODS, the contents of which are herein incorporated by reference.

It is presently preferred that system 50 validate incoming transactions and respond back to the store within several seconds.

FIG. 6 is a diagram emphasizing other aspects of the exemplary system.

ODFI (Originating Depository Financial Institution) 174 originates a PPD (Prearranged Payment and Deposits) ACH (Automated Clearing House) entry at the request of system 50. ODFI 174 sends the PPD entry to the Federal Reserve ACH system 175, which passes the entry to bank 178, which acts as a Receiving Depository Financial Institution (RDFI), where account 477 is issued debit, provided there are sufficient funds. Thus ODFI 174 effects an Electronic Funds Transfer (EFT).

When system 50 settles a transaction by causing the transfer of funds from account 477 of consumer 470 to account 61 of retailer 6, system 50 makes an entry in accounting system 170, to effectively increment an amount 173 owed by the retailer 6 to the owner of system 50. This amount is a fee for settling the transaction.

Circuitry in system 50 uses the ID number of the card, transmitted by circuitry in retailer 6, to access the associated PIN stored in the database. System 50 conditionally responds to the server in retailer 6 with a card-authorized signal, or a card-not-authorized signal. If the server receives a card-authorized signal, the transaction proceeds and the server then transmits a transaction amount to system 50.

Automated Clearing House (ACH) Settlement transmission occurs daily in batch fashion. (step 50). More specifically, system 50 compiles a file at end of day for submission to the ACH services. The required fields that this file contain are: date, time, transaction type, retailer ID, store ID, bank routing #, bank account #, amount of transaction. The specifics and file format is further defined with the ACH processor.

Status from ACH is collected and logged for review.

FIG. 8 shows another aspect of the first exemplary system, including an in-retailer server that is the gateway of communication leading to routing system 120. Routing system 120 includes a data structure 112, accessed by programs in routing system 120. Data structure 112 allows routing system 120 to select the path of a transaction request packet received from a retailer, as a function of a routing field in the packet. The routing field may contain an issuer identification number (IIN). For example, when routing system 120 receives a transaction request packet containing the number 451252 in the routing field, routing system 120 accesses entry 114, to send the packet to credit card system 4, allowing system 4 to authorize a credit card transaction. Credit card system 4 could be operated by the VISA Corporation.

When routing system 120 receives a transaction request packet containing the number 636010 in the routing field, routing system 120 accesses entry 115, to send the packet to system 50. When routing system 120 receives a transaction request packet containing the number 549035 in the routing field, routing system 120 accesses entry 116, to send the packet to debit card system 7, allowing system 7 to authorize a debit card transaction.

In summary, a point-of-sale payment transaction is effected via a retailer-branded card, originally issued as a gift card, and a personal identification number (PIN) as a mechanism of payment for a retail store transaction.

The POS allows a card such as card 215, originally issued as a gift card, to be used as a form of payment to debit a consumer checking account or savings account as a electronic fund transfer using the Federal Reserve Automatic Clearing House (ACH) for settlement.

Once the enrollment is complete and the prepaid monetary amount is depleted, the consumer can use the retailer-branded card, originally issued as a gift card, to pay for goods and services at any merchant point of sale location using the process and technology of this system, via the consumer's demand bank account.

Thus, card 215 starts as a commercially branded, stored-value, card that, when initially issued, is not dependent on the consumer's financial information, but is then later consumer's financial information associated with the demand bank account.

System 50 may be a single business entity. Alternatively, system 50 may include two non-affiliated business entities. The first business entity may handle the gift card phase processing of the card 215. When the first business entity detects that the monetary amount 2150 is zero, the first business entity may hand off processing the the second business entity, which will have handled the enrollment of the card. The second business entity then performs any needed ACH-related processing.

There are numerous other business configuration. For example, the owner of system 50 and the owner of system 120 may be affiliated.

### Second Exemplary Embodiment

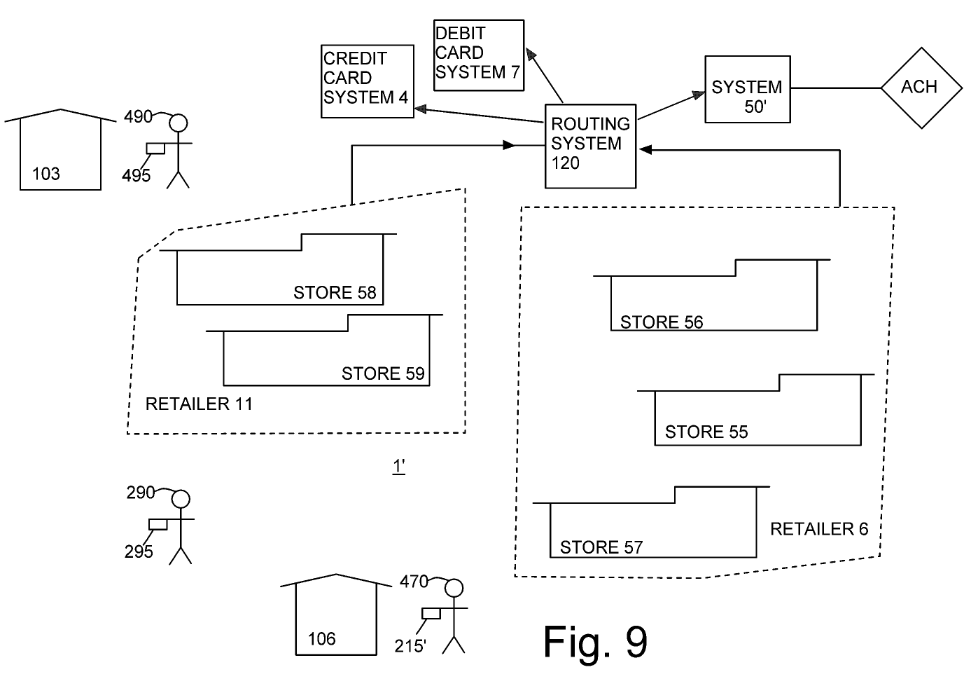

FIG. 9 shows a second exemplary system 1′. The second exemplary system has all the structure and function of the first exemplary system described above, plus the additional structure and function described below.

System 1′ includes multiple persons, such as person 290, person 470, and person 490. Person 470 carries a system-50′-branded card 215′, which was issued as a gift card for purchases from a variety of retailers, including retailer 6 and 11. Person 490 carries credit card 495, which is associated with an installment payment account of customer 490.

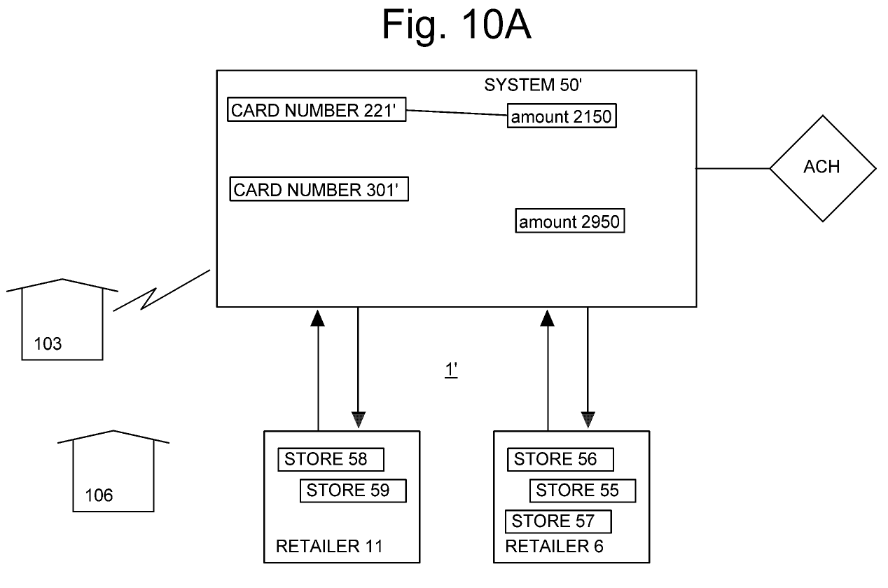

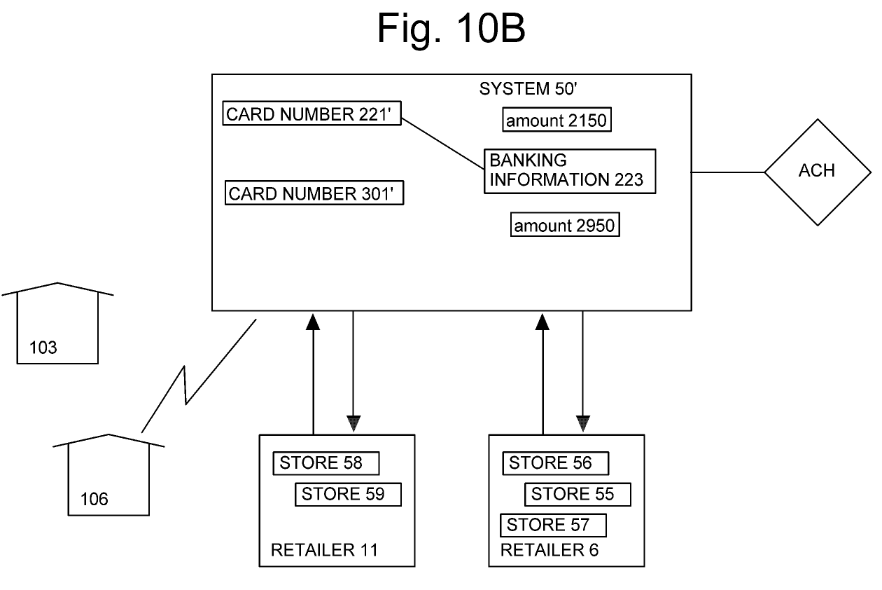

FIG. 10A emphasizes other aspects of System 1′. System 1′ includes gift card system 50′, which communicates with retailers 6 and 11, via routing system 120.

System 50′ receives signals from retailer 6, to validate customer authorization at the time of a retail transaction. Depending on the status of card 215′, system 50′ may either debit monetary amount 2150 reserved for transactions with a retailer 6 (debit a monetary amount associated with a gift card for shopping at certain retailers), or debit demand bank account 477, as discussed in more detail below.

The funds in amount 2150 are committed (limited to) purchases at certain retailers. The funds in demand bank account 477 are not so committed.

In response to a signal from system 50′, retailer 6, for example, allows a customer transaction to proceed.

System 50′ receives a data packet from retailer 6, the data packet containing a card number, such as the card number of the card held by a consumer 470. System 50′ then uses the data structures shown in FIG. 10A to find a monetary amount to 2150, which is the remaining pre-paid amount for the card of consumer 470.

The owner of system 50′ and the owner of retailer 6 are non-affiliated, meaning that they are not affiliates with respect to each other.

The owner of system 50′ and the owner of retailer 11 are non-affiliated.

The owner of retailer 6 and the owner of retailer 11 are non-affiliated.

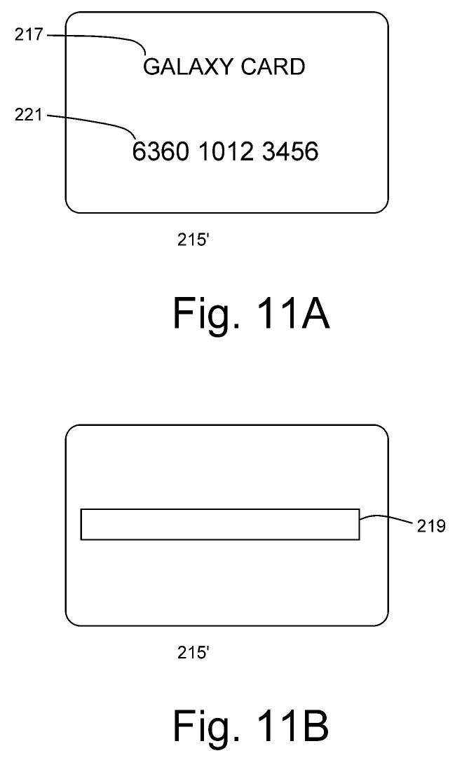

FIG. 11A shows a front, plan view of card 215′ branded for a payment service offered by the owner of system 50′. More specifically, card 215′ includes a prominent service mark 217, which in this case is “GALAXY CARD”. The face of card 215′ also presents a card number 221.

Card 215′ is held by person 470, who is a customer in system 1′.

FIG. 11B shows a back, plan view of card 215′. Card 215′ includes magnetic stripe 219 storing the ID number and other information on the reverse side. Tracks of stripe 219 also store the number 636010, which, in the second exemplary system, indicates a card associated with the owner of system 50′, in accordance with International Standard ISO 7812.

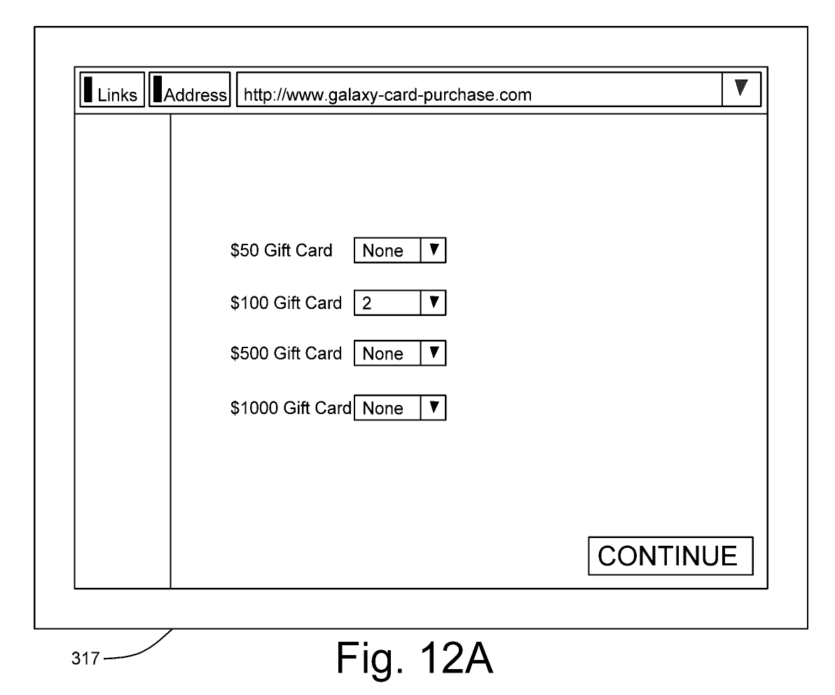

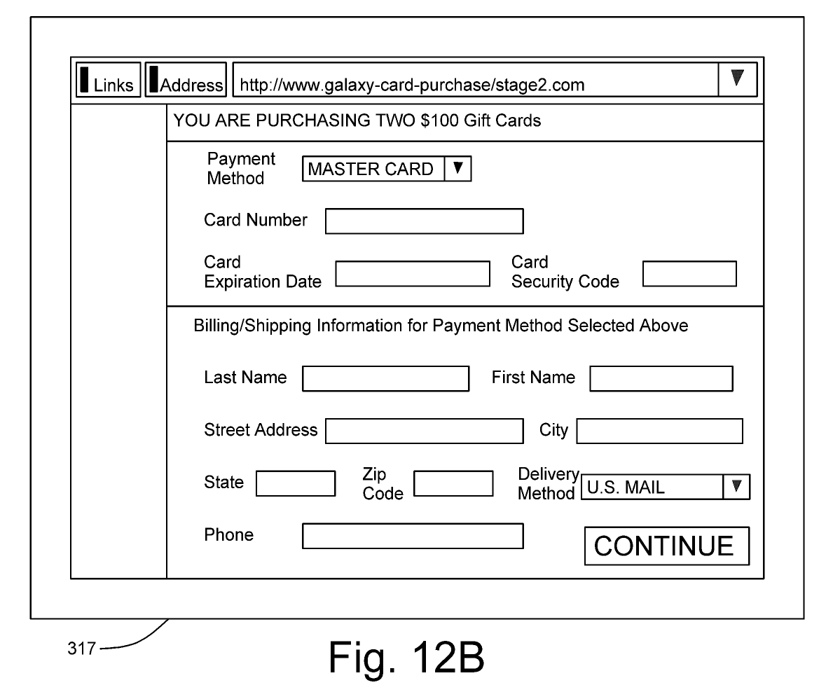

Card 215′ is issued as a result of an action by a consumer via the World Wide Web. More specifically, consumer 490 purchases card 215′ from home 103 of consumer 490. Consumer 490 uses a personal computer in home 103 to receive a page from a website. FIG. 12A shows computer display 317 displaying a card purchase page from the website. Consumer 490 uses a keyboard or mouse to complete fields shown on the computer display 317, including denomination and number of gift cards. Consumer 490 then activates the CONTINUE button, to send an HTTP message to system 50′ and receive a web page in response, as shown in FIG. 12B. At that time, display 317 includes a payment method field allowing the user to select a payment mechanism, such as MasterCard ™, Visa™, American Express™, or Galaxy. The payment information field includes a card number, card expiration date, and security code.

The billing information/shipping address fields shown on display 317 allow CONSUMER 490 to specify the destination to which card 215′ will be shipped. At the time of shipping, card 215′ does not display the name of consumer 470.

Consumer 490 then activates the CONTINUE button, causing data to be sent from home 103 to system 50′ via the World Wide Web. Circuitry in system 50′ uses the received data to generate monetary amount 2150.

Thus, consumer 490 funds monetary amount to 2150 from the installment account associated with card 495 of consumer 490. System 50′ then mails card 215′ to the home 103 of consumer 490. The installment account of card 495 is not automatically associated with card 215′ for future purchases. Instead, the funding of monetary amount 2150 from the installment account is a one-time transaction.

Consumer 490 may then physically deliver card 215′ to consumer 470.

Card 215′ is subsequently enrolled as the result of action by consumer 470 via the World Wide Web, using a process such as that described above in connection with the first exemplary system.

Thus, card 215′ is initially charged from an account of consumer 490, and then linked to an account of a consumer 470.

In the second exemplary method, the card, such as card 215′, has only a single payment mechanism, and the card remains a card having only a single payment mechanism. The single payment mechanism changes automatically, from gift card (stored-value card) to ACH debit card, in response to depletion of the stored-value. Although access to the ACH debit payment mechanism may be guarded by requiring manual entry of a PIN at the point of sale, this manual entry does not select between the stored value payment mechanism and the ACH debit payment mechanism. Instead, the system performs the selection automatically.

In summary, in the second exemplary method, a card-processor-branded pre-paid card is issued when the card is purchased by a first person via a home computer. The system then ships the card to a postal address of the first person, and the first person then transfers the card to a second person. The second person then enrolls the card into an ACH debit system, via her home computer. At the time of card issuance, the card does not display the name of the second person.

### Third Exemplary System

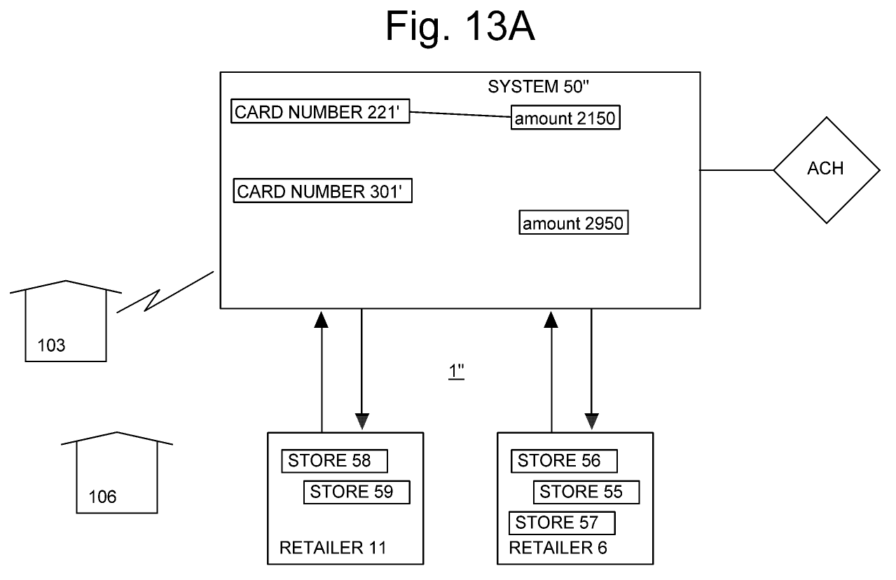

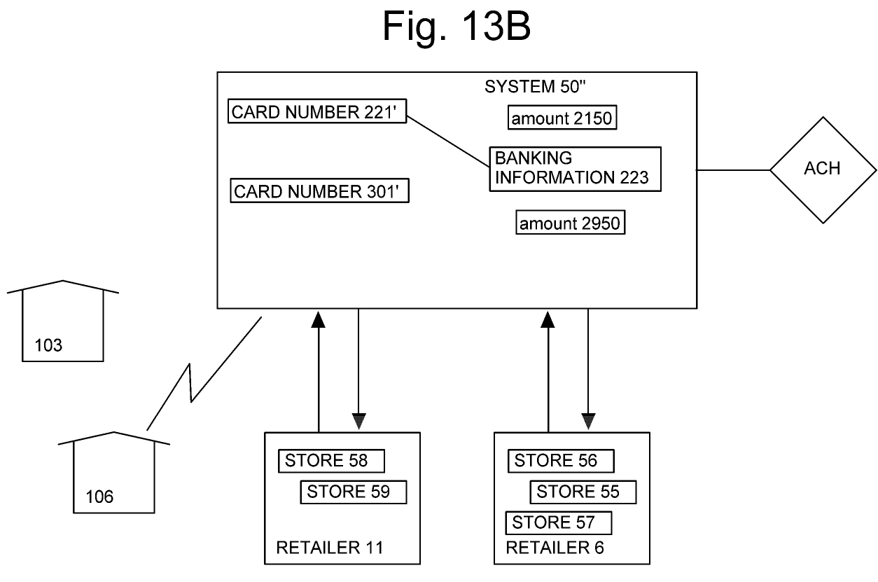

FIG. 13A shows a third exemplary system 1″. The third exemplary system has all the structure and function of the second exemplary system described above, plus the additional structure and function described below.

System 1″ includes multiple persons, such as person 290, person 470, and person 490. Person 470 carries a system-50″-branded card 215″, which was issued as a gift card for purchases from a variety of retailers, including retailer 6 and 11. Person 490 carries credit card 495, which is associated with an installment payment account of customer 490.

System 1″ includes gift card system 50″, which communicates with retailers 6 and 11, via routing system 120.

System 50″ receives signals from retailer 6, for example, to validate customer authorization at the time of a retail transaction. Depending on the status of card 215″, system 50″ may either debit monetary amount 2150 reserved for transactions with a retailer 6 (debit a monetary amount associated with a gift card for shopping at certain retailers), or debit demand bank account 477.

The funds in amount 2150 are committed (limited to) purchases at certain retailers. The funds in demand bank account 477 are not so committed.

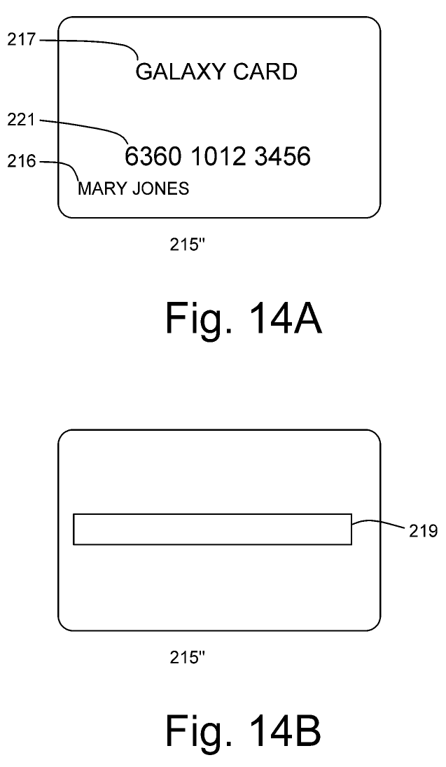

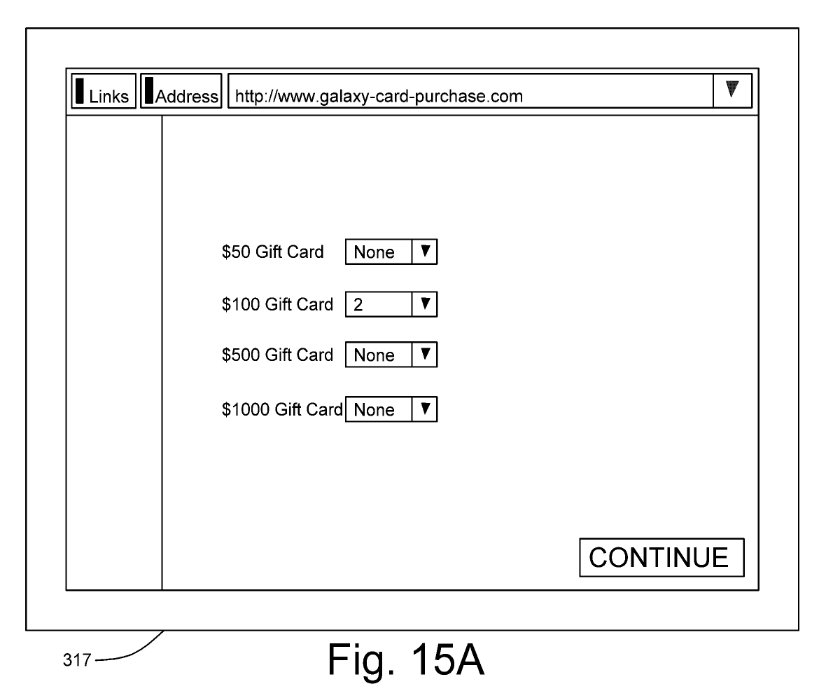

FIG. 14A shows a front, plan view of card 215″ branded for a payment service offered by the owner of system 50″. More specifically, card 215″ includes a prominent service mark 217, which in this case is “GALAXY CARD”. The face of card 215″ also presents a card number 221.

Card 215″ is held by person 470, who is a customer in system 1″.

FIG. 14B shows a back, plan view of card 215″. Card 215″ includes magnetic stripe 219 storing the ID number and other information on the reverse side. Tracks of stripe 219 also store the number 636010, which, in the third exemplary system, indicates a card associated with the owner of system 50″, in accordance with International Standard ISO 7812.

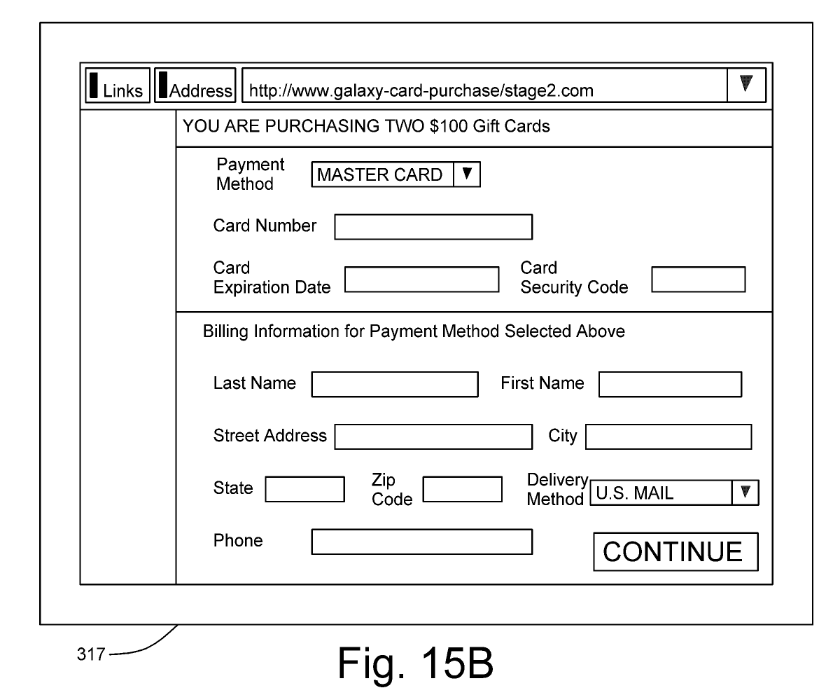

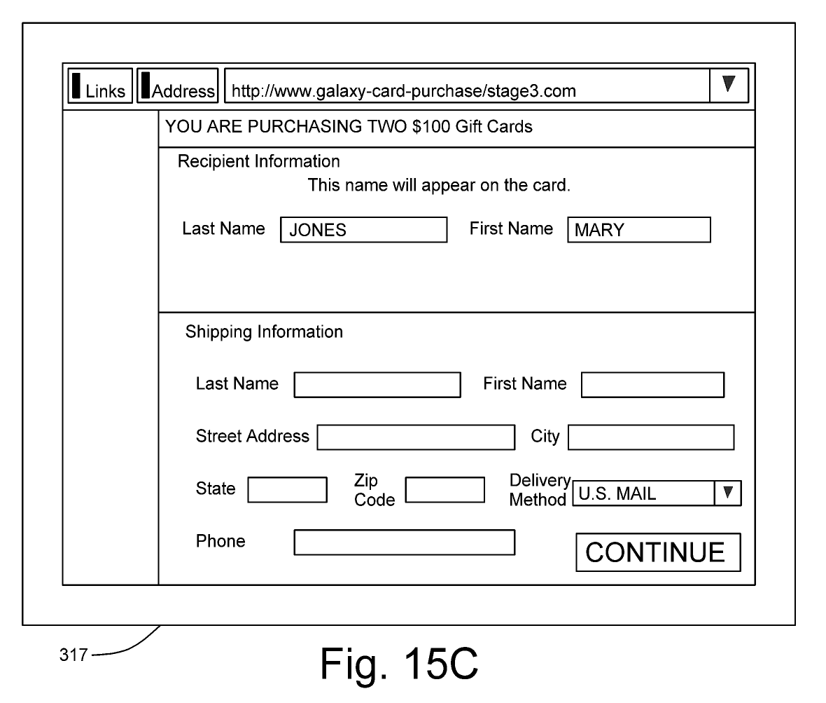

Card 215″ is issued as a result of an action by a consumer via the World Wide Web. More specifically, consumer 490 purchases card 215″ from home 103 of consumer 490. Consumer 490 uses a personal computer in home 103 to receive a page from a website. FIG. 15A shows computer display 317 displaying a card purchase page from the website. Consumer 490 uses a keyboard or mouse to complete fields shown on the computer display 317, including denomination and number of gift cards. Consumer 490 then activates the CONTINUE button, to send an HTTP message to system 50″ and receive a web page in response, as shown in FIG. 15B. At that time, display 317 includes a payment method field allowing the user to select a payment mechanism, such as MasterCard™, Visa™, American Express™, or Galaxy. The payment information field includes a card number, card expiration date, and security code.

The billing information/shipping address fields shown on display 317 of FIG. 15B allow consumer 490 to the billing address of card 495.

Consumer 490 then activates the CONTINUE button, to send an HTTP message to system 50″ and receive a web page in response, as shown in FIG. 15C. The shipping address fields shown on display 317 of FIG. 15C allow consumer 490 to specify the name of the recipient and the destination to which card 215″ will be shipped. At the time of shipping, card 215″ displays the name 216 (“MARY JONES”) of consumer 470.

Consumer 490 then activates the CONTINUE button, causing data to be sent from home 103 to system 50″ via the World Wide Web. Circuitry in system 50″ uses the received data to generate monetary amount 2150.

Thus, consumer 490 funds monetary amount to 2150 from the installment account associated with card 495 of consumer 490. System 50″ then mails card 215″ to the home 106 of consumer 470. The installment account of card 495 is not automatically associated with card 215″ for future purchases. Instead, the funding of monetary amount t 2150 from the installment account is a one-time transaction.

Text on the packaging for card 215″, on the back of card 215″, or on a POS display, directs consumer 470 to enroll card 215″.

Card 215″ is subsequently enrolled as the result of action by consumer 470 via the World Wide Web, using a process such as that described above in connection with the first exemplary embodiment.

In summary, in a third exemplary method, a card-processor-branded pre-paid card is issued when the card is purchased by a first person via a home computer. The system then ships the card to a postal address of a second person. The second person then enrolls the card into an ACH debit system, via her home computer. At the time of card issuance, the card displays the name of the second person.

### Other Embodiments

As an alternative to enrollment via the Web, the customer is processed at the retailer customer service area or self service kiosk, where the magnetic stripe 219 of card 215 is scanned (step 5). Of course, there are alternatives to the magnetic stripe, such as a bar code.

A personal identification number (PIN) entry is received from the consumer into the terminal (step 10), and a personal check is scanned (step 15). This scanning captures the image of the check, the bank routing number, and the bank account number. (Another alternative is to mail in a voided check.) The collection of the card identification number, PIN, the bank routing and account number read from the check, then becomes part of data sent to system 50, in which they are stored in association in a database (step 20).

In an alternative embodiment, the system may use a PIN, Biometric Signature, or RFID for authentication.

In an alternative embodiment, the card may at some point be concurrently enabled with multiple payment mechanisms, or sources, selectable by the consumer using the keypad at the point of sale.

As shown at 221 in FIG. 3A, the face of card 215 may display the IIN and card ID number stored on magnetic stripe 219. Alternately, the face of card 215 may display numbers corresponding to the numbers stored on magnetic stripe 219, the correspondence being established by references stored elsewhere in the system.

The system can be used at any retail facility, including supermarkets, convenience stores, gas stations, general merchants, restaurants etc.

Benefits, other advantages, and solutions to problems have been described above with regard to specific examples. The benefits, advantages, solutions to problems, and any element(s) that may cause any benefit, advantage, or solution to occur or become more pronounced are not critical, required, or essential feature or element of any of the claims.

Additional advantages and modifications will readily occur to those skilled in the art. The invention in its broader aspects is therefore not limited to the specific details, representative apparatus, and illustrative examples shown and described. Accordingly, departures may be made from such details without departing from the spirit or the scope of Applicants' general inventive concept. The invention is defined in the following claims. In general, the words “first,”“second,” etc., employed in the claims do not necessarily denote an order.

What is claimed is:

1. A method for a system having a plurality of retailers, a first person, and a bank checking account owned by the first person, the method operating with a card that was transferred to the first person at a time when the card was having only a single payment source, the single payment source being a monetary amount not associated with any bank account, the method comprising:
associating the card with the checking account owned by the first person; and
performing a purchase, to debit the checking account.

2. A system for operating with a plurality of retailers, a first person, a bank checking account owned by the first person, and a card that was transferred to the first person at a time when the card was having only a single payment source, the single payment source being a monetary amount not associated with any bank account, the system comprising:
circuitry that acts to associate the card with the checking account owned by the first person; and
circuitry that acts to conduct a purchase transaction, to debit the checking account.

3. A system for operating with a plurality of retailers, a first person, a checking account owned by the first person, and a card that was transferred to the first person at a time when the card was having only a single payment source, the single payment source being a monetary amount not associated with any bank account, the system comprising:
means for associating the card with the checking account owned by the first person; and
means for conducting a purchase transaction, to debit the checking account.

4. A method for a system having a plurality of retailers, the method operating with a card that has been issued as a stored-value card, the method comprising:
performing a purchase by debiting a monetary amount associated with the card;
detecting depletion of the monetary amount; and
responsive to the detecting step, enabling purchases to be performed by debiting a bank checking account.

5. The method of claim 4 further including
accepting an enrollment transaction initiated by a holder of the card, the enrollment transaction including associating the card with an account number of the bank checking account.

6. The method of claim 5 wherein the holder of the card initiates the enrollment transaction before the step of detecting depletion.

7. The method of claim 5 wherein the enrollment transaction includes associating the card with personal identification number selected by the holder of the card.

8. The method of claim 5 wherein the storage medium of the enrolled card encodes no more information than was encoded thereupon prior to enrollment of the card.

9. The method of claim 4 wherein detecting depletion of the monetary amount includes detecting whether the monetary amount is 0.

10. The method of claim 4 wherein
the monetary amount is reserved for purchases with a first retailer; and
at the time of issuance of the card, the card prominently displays a name designating the first retailer.

11. The method of claim 10 wherein
a person is an owner of the bank checking account, and
at the time of issuance of the card, the card does not display the name of the person.

12. The method of claim 10 wherein the card is issued in a store of the first retailer.

13. The method of claim 10 wherein
a person is an owner of the bank checking account, and the method further includes
accepting an enrollment transaction initiated by the person, the enrollment transaction including associating the card with an account number of the bank checking account.

14. The method of claim 13 wherein the person initiates the enrollment via the World Wide Web.

15. The method of claim 13 wherein the person initiates the enrollment transaction from a home of the person.

16. The method of claim 13 wherein the person initiates the enrollment transaction from a store of the retailer.

17. The method of claim 10 wherein the card remains a single payment mechanism card.

18. The method of claim 4 wherein
the monetary amount may be applied to purchases with a plurality of retailers; and
at the time of issuance of the card, the card prominently displays a name designating an entity that is not affiliated with any one of the plurality of retailers.

19. The method of claim 18 wherein
the issuance is of the card is initiated by a first person;
a second person is an owner of the bank checking account, and
at the time of issuance of the card, the card does not display the name of the second person.

20. The method of claim 19 further including
accepting an enrollment transaction initiated by the second person, the enrollment transaction including associating the card with an account number of the bank checking account.

21. The method of claim 19 wherein issuing the card includes sending the card to a postal address of the first person.

22. The method of claim 18 wherein the card is issued as a result of an action by person via the World Wide Web.

23. The method of claim 18 wherein
the issuance is of the card is initiated by a first person;
a second person is an owner of the bank checking account, and
at the time of issuance of the card, the card displays the name of the second person.

24. The method of claim 23 further including
accepting an enrollment transaction initiated by the second person, the enrollment transaction including associating the card with an account number of the bank checking account.

25. The method of claim 23 wherein issuing the card includes transferring possession of the card to the second person, by sending the card to a postal address of the second person.

26. The method of claim 4 wherein detecting depletion of the monetary amount includes detecting whether the monetary amount is insufficient to complete the current purchase and applying the monetary amount to the current purchase and an amount from the bank checking account to the current purchase.

27. A system for operating with a plurality of retailers, and a card that has been issued as a stored-value card, the system comprising:
circuitry that conducts a purchase transaction by debiting a monetary amount associated with the card;
circuitry that detects depletion of the monetary amount, to generate a first signal; and
circuitry that enables, responsive to the first signal, purchases to be performed by debiting a bank checking account.

28. A method for a system having a plurality of persons; a plurality of cards issued under authority of a retailer; a first signal common to the plurality of cards; a routing system for receiving a signal and generating a network address in response to the received signal, the routing system including a plurality of wide area communication links, the routing system being configured using the first signal, the system further including a second signal on a first card in the plurality of cards; and a second system storing an association between the second signal and account information, the method comprising:
the steps, performed at the retail site, of:
receiving the first and second signals from the first card;
sending the first and second signals into the routing system, to cause the second system to perform the steps of
detecting depletion of a monetary amount associated with the first card, the monetary amount being committed to purchases with the retailer;
responsive to the detecting step, determining whether the first card can effect payment,
responsive to the determining step, conditionally sending a message to cause an institution to send an ACH entry to the Federal Reserve ACH system, to pass the entry to a bank, where an account is issued a debit, to cause a transfer of funds to the owner of the retail site, and making an entry in an accounting system, to effectively increment an amount owed by the owner of the retail site to the owner of the second system,
wherein the method further includes the step, performed at the retail site, of:
conditionally effecting a transaction with a holder of the first card, depending on a signal received from the second system.

29. The method of claim 28 further including the steps, performed before the detecting step, of receiving the second signal;
receiving account information;
storing the association between the second signal and the account information.

30. The method of claim 28 wherein the signal received from the second system includes an indication whether the card is authorized to effect payment.

31. The method of claim 28 wherein the second system is in the United States of America.

32. The method of claim 28 wherein the account is a demand account.

33. The method of claim 28 wherein the information corresponding to the account includes an account number previously presented to a consumer.

34. The method of claim 28 wherein the information corresponding to the account includes an account number previously presented to a consumer user on a paper statement generated by the financial institution managing the account.

35. The method of claim 34 wherein the financial institution is a bank or credit union.
